(19) United States
(12) Patent Application Publication
(10) Pub. No.: US 2009/0157908 A1
(43) Pub. Date: Jun. 18, 2009

(54) Software Driver Device

(76) Inventor: Alain Cadio, Carros (FR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/378,720

(22) Filed: Feb. 18, 2009

Related U.S. Application Data
(63) Continuation of application No. 11/387,041, filed on Mar. 21, 2006, now abandoned.

(51) Int. Cl. G06F 3/00

(52) U.S. Cl. 710/8

(57) ABSTRACT

An interface device disposed between a host and peripheral device is disclosed. The device stores drivers, utility software and applicative data for the peripheral device. The interface device appears to first be a CD driver for purposes of loading drivers, software and data into the host. Then it switches to directly couple the host and peripheral device.

### REFERENCE TO RELATED APPLICATION

This application claims priority to U.S. application Ser. No. 11/387,041, filed Mar. 21, 2006.

### FIELD OF THE INVENTION

The invention relates to the field of software drivers, and in particular to a hardware implementation of a software driver.

### PRIOR ART

Software drivers, also known as device drivers, are computer code or routines that link an operating system of a computer to a peripheral device. Typically, a programmer with an understanding of the peripheral device's command language, writes machine level code necessary to perform the functions requested by an application or an operating system. Such drivers are in wide use for printers, image scanners, digital cameras, video adapters, network cards, sound cards, local buses, storage devices (such as hard disk, CD ROMs, floppy disks, etc. for implementing different file systems), as well as other peripheral devices.

Most often, each peripheral device requires its unique driver. And to the dismay of many computer users, the switching of one identical appearing peripheral device with another may require a different driver because of some improvement in a later-produced peripheral device. Virtually every computer user has suffered with the mishaps that occur with the installation of drivers. All too often, the operating system seems to make calls on the wrong driver, a new driver did not replace an old driver, or an installed driver was not put into permanent memory and disappeared from RAM when the computer was turned off. Nearly every computer user has his or her stories of unhappy experiences with drivers.

Generally, the driver is installed when a new peripheral is connected to a computer through, for instance, a CD drive or downloaded from a network. In theory, the driver should become a permanent part of the operating system and should be automatically selected once installed so that the peripheral device operates as expected.

### BRIEF DESCRIPTION OF THE DRAWINGS

FIG. 1 illustrates a computer system having a peripheral device with a driver device as taught by the present invention.

FIG. 2 is a block diagram of the driver device of the present invention.

FIG. 3 is a more detailed block diagram of the driver device of FIG. 2.

FIG. 4 is a flow diagram illustrating the steps associated with the use of the driver device of the present invention.

### DETAILED DESCRIPTION

An interface device is described for providing a software driver to a computer. As a direct extension, the device can of course be used for providing additional software or pre-defined data. In the following description, numerous specific details are set forth such as specific connectors, buses and implementing steps. It will be apparent to one skilled in the art, that the present invention may be practiced without these specific details. In other instances, well-known software code and other details are not described in detail in order to not unnecessarily obscure the present invention.

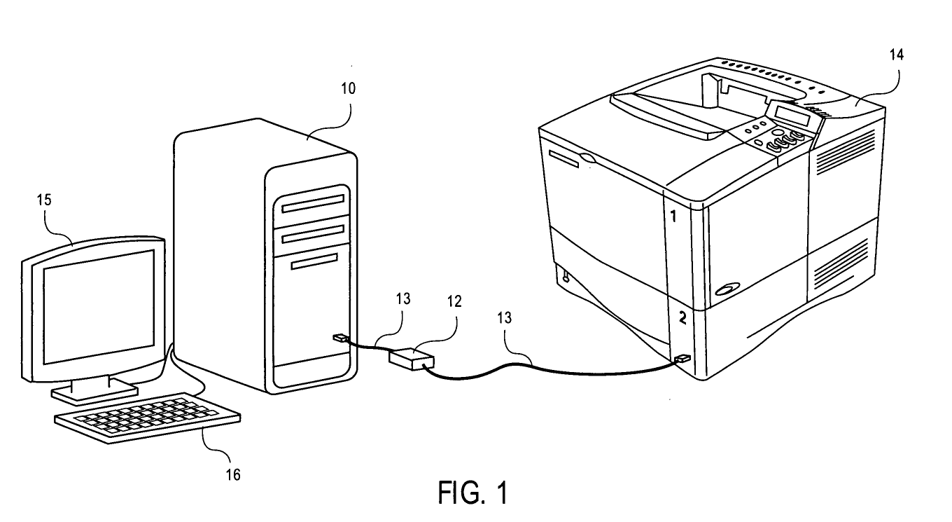

Referring first to FIG. 1, a computer system is illustrated having a central processing unit (CPU) 10, a display 15, keyboard 16, and a peripheral device, specifically, a printer 14. The interface driver device 12 of the present invention is illustrated connected within a cable 13. The cable 13 connects the CPU 10 with the printer 14 through the device 12. It will be apparent from the description below that a cable such as the cable 13 may be used to connect a computer such as a CPU 10 to any one of a plurality of peripheral devices. Any peripheral device for which a driver is needed, may employ the device 12.

While in FIG. 1 the device 12 is shown as being connected into the cable 13, the device 12 may be, as an example, contained within the peripheral device 14 or other peripheral device, such that it interfaces between the CPU 10 or other computer and the peripheral device. Moreover, the device 12 may be embedded within a connector which connects either to the computer or to the peripheral device. Also, the device 12 can be at the end of one cable, the other end of which connects with a connector used to interconnect a computer and peripheral device.

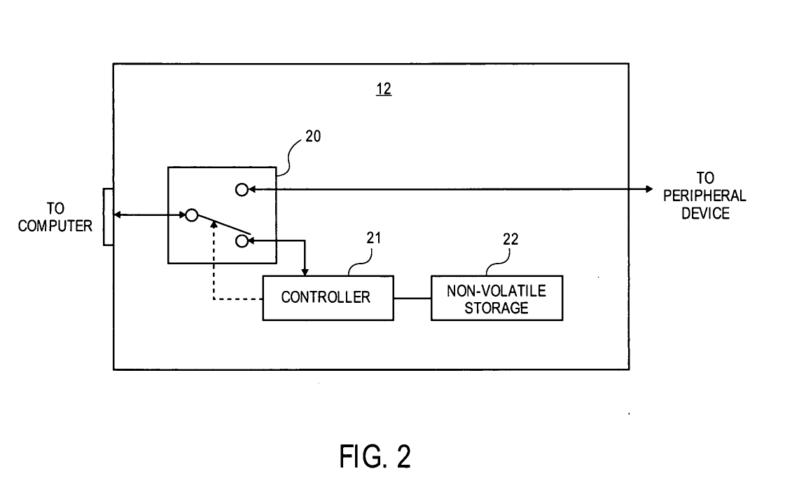

In FIG. 2, the interface device 12 comprises a switch 20, a controller 21, and non-volatile storage 22. The switch 20 may be a mechanical switch, relay, or electronic switch, controlled by the controller 21. The controller 21 may be an ordinary microcontroller or microprocessor having a program which controls its operation. The controller 21 is connected to non-volatile storage 22, which may be, as an example, a flash memory.

In practice, the controller 21 receives power for its operation and for the control of the switch 20 from the computer. Power may be provided on dedicated lines, or the power may be phantom fed over communication lines. The device 12 may alternatively receive power from its own power source or from the peripheral device.

The switch 20 allows the computer to either communicate directly with a peripheral device or the controller 21. In one embodiment the controller 21 receives power even when the switch 20 connects the computer directly to the peripheral device.

As will be discussed, when the controller is connected to a computer, the device appears to the computer to be, for instance, a CD drive. The computer detecting the faux CD drive, addresses it as it would any other CD drive. The interface device 12 then operates as a CD drive to download the drivers, plus potential additional software and data, to the computer. After this is completed, the switch changes state, thereby directly connecting the computer to the peripheral device. With the driver installed, the computer now can operate the peripheral device.

In operation, when the interface device is plugged on the computer or when the computer system is turned on, the controller 21 assures that the switch 20 is in the position shown in FIG. 2. In this position, the controller 21 is in communication with the CPU 10, and it can be determined if the software driver, plus additional software and data, for the peripheral device 14 are installed in the computer. If the controller 21 determines that the driver and the additional software and data are already in the CPU 10's memory, the controller 21 changes the switch state. If the driver and the additional software and data are not installed, the controller 21, in conjunction with the CPU 10's operating system, downloads the driver plus the additional software and data from the non-volatile storage 22 and loads it into the computer's memory. Once installed in the computer's memory, the controller 21 causes the switch to change its state such that the computer is directly connected to the peripheral device.

In practice, each interface device 12, with its non-volatile storage 21, is associated with a particular peripheral device and includes the drivers and the additional utility software for that peripheral device. Where the device 12 is embedded or contained within the peripheral device, no ambiguity exists as to which driver should be installed to operate the peripheral device. Where the device 12 is in a cable, as shown in FIG. 1, clear marking or labeling is used on the device 12 to associate it with the correct peripheral.

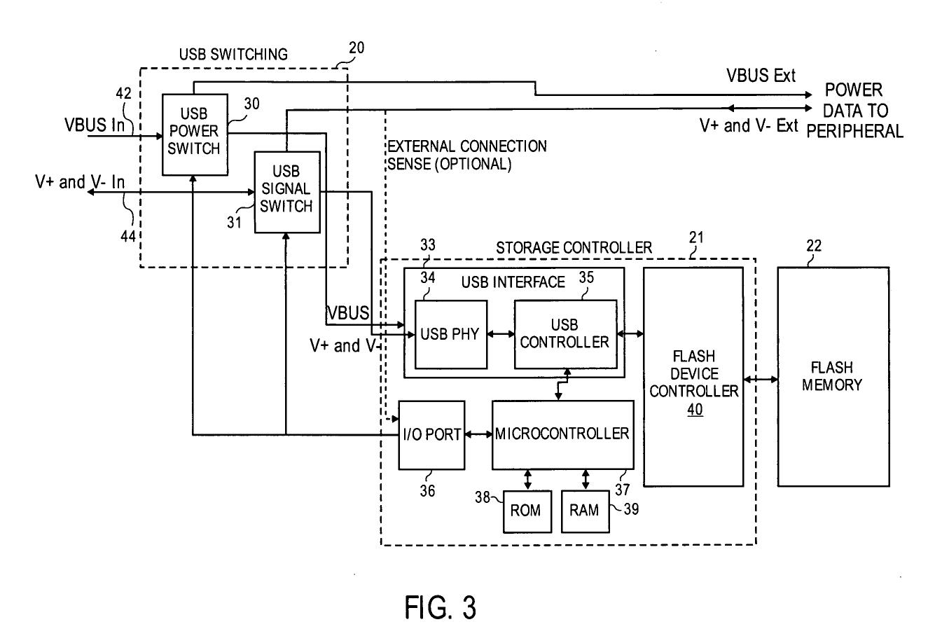

FIG. 3 shows an embodiment of the interface device of FIG. 2 in connection with Universal Serial Bus (USB). The switch 20 of FIG. 2 is again shown along with the controller 21 and the memory 22. Data is provided on the bus 44 and power on the VBUS 42. This power may be used both by the controller and the peripheral device. The switch 20 of FIG. 2 includes two switches in FIG. 3: the USB power switch 30, and the USB signal switch 31. Switch 30 switches the power from the controller 21 and memory 22 to the peripheral device. The switch 21 may also continually provide power to the controller and either provide, or not provide, power to the peripheral device. The signal switch 31 connects the data bus 44 either to the controller 21 or to the peripheral device. Both switches 30 and 31 are controlled by a signal from the I/O port unit 36 of the controller 21.

The controller 21 includes a microcontroller 37 having a read-only memory (ROM) 38 and a random access memory (RAM) 39. The ROM 38 stores a program for controlling the operation of the controller, while the RAM 39 is used as a “scratch pad” and the like by the microcontroller 37. The USB signals are received by the unit 33 which includes a USB PHY unit 34 and a USB controller 35. Together these constitute the USB interface. The USB PHY unit 34, converts the physical layer signals, particularly the data signals, to signal levels and waveforms appropriate for the microcontroller. The USB controller 35 controls a higher layer of protocol for the USB bus. The controller 35 operates in conjunction with a microcontroller 37 and the flash memory controller 40 to access the flash memory 22. As mentioned earlier, the flash memory 22 stores the software drivers and can store other configuration software or application software associated with the peripheral device. An external connection may also be used which informs the controller 21 of the presence of the peripheral device.

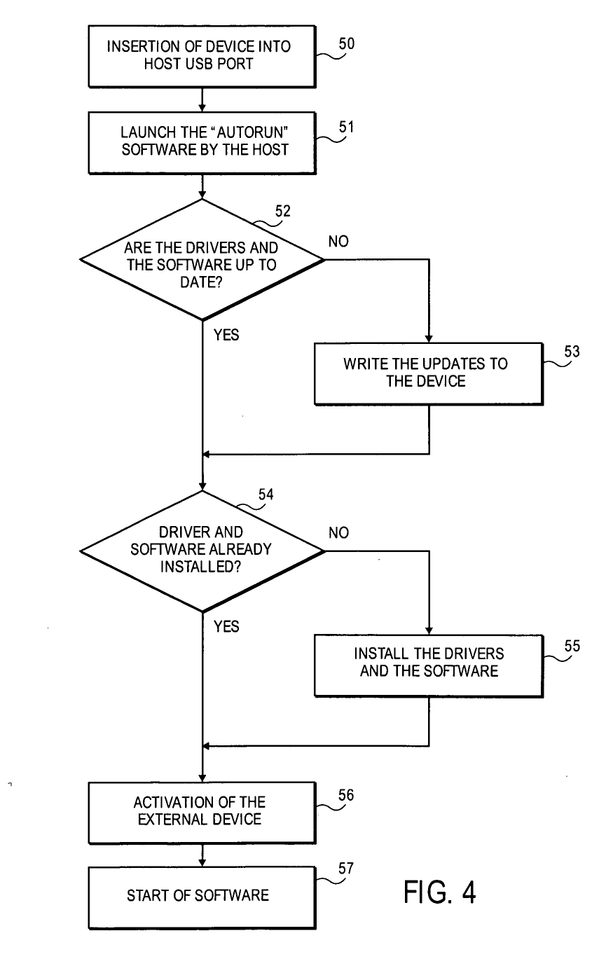

Referring to FIG. 4, the operation of the interface device of FIG. 3 is described. At step 50, the device of FIG. 3 (device 12 of FIG. 1) is connected to the host USB port of the computer such as the CPU 10 of FIG. 1. From the standpoint of the host, the device 12 appears to be, for instance, a CD ROM drive containing an auto start CD.

The host then launches an auto run program as indicated by step 51 of FIG. 4. As would occur with any other auto start CD, the host would start the application that is stored on the device 12.

As indicated by step 52, the auto start application checks to determine if the device itself contains the latest version of the drivers and of any related software or data associated with the peripheral device. To do this, the auto start application checks the version of the installed drivers and software (if any). Then, if an Internet connection exists on the host, the auto start program typically downloads any newer versions of the driver and software from a web server and copies them to the flash memory 22 of FIG. 3. Typically, a special command is sent across the USB I/O channel and, at the appropriate time, the new drivers and software are sent across the I/O channel and installed in the flash memory 22 as indicated by step 53 of FIG. 4.

Once the latest version of the drivers and software are present in the memory 22, the auto start program determines if they are already installed on the host. This is indicated by step 54 of FIG. 4. If they are installed, then the controller 21 can change the state of the switches of FIG. 3. If on the other hand they are not installed, the drivers and other software from flash memory 22 are installed as it would be from an ordinary CD drive on which the drivers are stored, as indicated by step 55 of FIG. 4.

Once the drivers and other software are installed in the host, or in the case where they were already installed, the activation of the external device (peripheral device) is performed by sending a command across the USB I/O channel. This operation discontinues the CD ROM-like operation of the interface device 12 and connects the host's USB port directly to the peripheral device. From the host's viewpoint it appears as if the CD ROM was unplugged, immediately followed by a new USB device (the peripheral device) being plugged in. Once the controller has caused the switch 20 to connect the peripheral device, the peripheral device is ready and the auto run application can execute the software. This is shown by step 57 of FIG. 4.

Thus, through use of an interface driver device the host first is used to update the software in the device, the software is loaded into the host where appropriate, and lastly, the device causes the host to be directly connected with the peripheral device once the host has the correct software.

What is claimed is:

1. An apparatus for coupling an external device to a host comprising:
a connector for engaging a mating connector on the host for providing an electrical path with the host from the external device; and
an interface device coupled to the connector having a switch, a controller and non-volatile device storage, the switch being controlled by the controller to either couple the host to the external device or to couple the device storage to the host, the device storage storing software drivers, the controller causing the drivers from the device storage to be accessible by the host, for storage in the host, the drivers providing compatibility between the host and the external device.

2. The apparatus of claim 1, wherein the interface device is integral with the connector.

3. The apparatus of claim 1, wherein the interface device is coupled in the electrical path.

4. The apparatus of claim 1, wherein the interface device is within the external device.

5. The apparatus of claim 1, wherein the interface device receives power from the host.

6. The apparatus of claim 1, wherein the connector is a USB connector.

7. The apparatus of claim 1, wherein the device storage is flash memory.

8. A method comprising the steps of:
connecting an interface device having a memory to a host computer, the memory containing software drivers, additional software and applicative data for allowing the host to operate with a peripheral device, the interface device also allowing the host to communicate with the peripheral device through a switch which either couples the host to the peripheral device or the memory;
downloading the drivers and additional software from the memory to the host, if the host does not have the drivers stored within its memory; and
bypassing the previous step, if the host has the drivers and software stored in its memory.

9. A method comprising:
connecting to a computer an interface device which appears to the computer to be a CD drive;
checking by the interface device to determine if the computer is storing drivers for a peripheral device;
communicating between the computer and interface device, drivers for the peripheral device if the computer is not storing the drivers; and
switching within the interface device such that the computer is directly connected to the peripheral device when the computer is storing the drivers.

10. The method of claim 9, including causing the computer to check via the Internet to determine if the interface device is storing the latest version of drivers, software and data for the peripheral device.

11. The apparatus of claim 1, wherein the interface device causes the host via the Internet to check if the device storage contains the latest version of the drivers and, if not, download the latest version of the drivers for storage in the device storage.
